(19) United States
(12) Patent Application Publication
(10) Pub. No.: US 2007/0129024 A1
(43) Pub. Date: Jun. 7, 2007

(54) Transmitter

(75) Inventor: Tomohiro Kikuma, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/600,060

(22) Filed: Nov. 16, 2006

(30) Foreign Application Priority Data
Dec. 7, 2005 (JP) 2005-353376

(51) Int. Cl. H04B 1/02; H04B 7/02

(52) U.S. Cl. 455/101

(57) ABSTRACT

At least two types of amplifiers having different saturation output power values are used as a transmitting power amplifier (total number, N) each of which is mounted on N of antenna systems respectively. That is, at least one of transmitting power amplifier among N of transmitting power amplifiers has a saturation output power value different from a saturation output power of the others. Transmission control section selects an antenna system to be used, which satisfies transmitting regulation, among N of antenna systems based on modulation information, such as a coding rate, a modulation maltivalue number, the number of active antenna systems, and a receiving error rate of a receiver.

### FIELD OF THE INVENTION

The present invention relates to a transmitter comprising a plurality of antenna systems which are configured with a plurality of transmitting antennas and a plurality of transmitting power amplifiers disposed at each of the plurality of transmitting antennas.

### DESCRIPTION OF THE RELATED ART

A transmitter for a simple radio communication system has only one antenna system. On the other hand, a transmitter comprising an array antenna unit or a transmission diversity function has a plurality of antenna systems (for example, refer to the publication of Japanese Patent Application Laid-open No. 2004-135263; Patent Document 1). Further, there is also another radio communication system in which the number of antennas to be used is switched in accordance with a transmitting rate.

A conventional transmitter having a plurality of antenna systems is shown in FIG. 3. This conventional transmitter comprising, as shown in FIG. 3, a digital signal processing section 10, a digital/analog conversion processing section 11, an analog signal processing section 12, N of transmitting power amplifiers (1)-(N) 13, and N of transmitting antennas 15.

The number of antenna systems is described as N (>1) in FIG. 3. A signal generated by performing digital signal processing of source information data at the digital signal processing section 10 is converted into an analog signal through the digital/analog signal conversion processing section 11, and performed analog signal processing at the analog signal processing section 12. The signal performed analog signal processing is divided into plural signals, and transmitting power of the divided signals are amplified at the transmitting power amplifiers (1)-(N) 13 respectively, and radiated from the antennas 15 into the air.

Here, radio engineers can easily understand that, as a rate of information transmission per unit interval of frequency and/or per antenna system becomes higher, an allowable distortion, with which the transmitting signal can be receivable, is highly required, that is, the higher modulation accuracy is required, in general. Generally, the modulation accuracy depends on such as nonlinearity distortion of a transmitting power amplifier, a phase noise of an oscillator, and the like.

Hereinafter, a transmitting power amplifier will be explained. FIG. 4 shows a relationship between a gain and power consumption of the amplifier with respect to output signal power of the transmitting power amplifier. In order to amplify a signal without any distortion, a gain is desirably constant regardless of output power. However, because output signal power from the transmitting power amplifier has an uppermost limit (saturation output power), an increase of output power hits a peak around the saturation output power even if input power to the transmitting power amplifier is increased. Therefore, a back-off needs to be adjusted up to output power at which the distortion by the amplifier is allowable.

Next, consumption power of a transmitting power amplifier will be explained. The consumption power of the transmitting power amplifier P_{dc} is expressed by the following equation (1).
P_{dc}=Pₛₐₜ/η max (1)

In the equation (1), Pₛₐₜ is the saturation output power, and η max is a maximum effect determined by a configuration of an amplifier.

When the maximum effect, η max, is fixed, it is clear from the equation (1) that the consumption power of the transmission power amplifier P_{dc} does not depend on the back-off, but depends on the saturation power of the amplifier (the consumption power is constant regardless of the back-off, in FIG. 4). On the other hand, as shown in FIG. 4, the nonlinearity distortion of a signal generated at the transmitting power amplifier depends on the back-off. The larger the back-off is, the lower the nonlinearity distortion is (modulation accuracy is improved). For example, when a modulation multivalue number is increased from BPSK (Binary Phase Shift Keying)−>QPSK (Quadrature Phase Shift Keying)−>16QAM (Quadrature Amplitude Modulation)−>64QAM in order to increase a transmission rate, the back-off for satisfying the modulation accuracy becomes large in sequential from BPSK, QPSK, 16QAM, 64QAM. Further, in general, the higher a saturation output power Pₛₐₜ is, the larger a physical size of the transmitting power amplifier is. That is the explanation for a transmitting power amplifier.

Next, a general transmitting regulation with respect to a transmitter in a radio transmission system will be explained. A transmitter generally needs to satisfy a regulation of a radio transmission system regulated in each frequency band. The transmitting regulation is, for example, a transmission spectrum regulation such as the center frequency, the band, and the channel leakage power, and regulations such as the highest transmitting power, and for modulation distortion. An example shown in FIG. 5 is a transmission spectrum of a transmitter having a plurality of antenna systems. In FIG. 5, the dash line shows the transmitting spectrum regulation and the full line shows the transmitting spectrum of the transmitter, where a signal transmitted from each antenna system satisfies the spectrum regulation.

When a transmitter having a plurality of antennas is applied to the system, average transmitting power T_{xPow} at each antenna to satisfy the highest transmitting power regulation needs to satisfy the following equation (2):
N*T_{xPow}≦T_{xPow}(max) (2)

At equation (2), N is the number of transmitting antenna systems to be used in the transmitter, T_{xPow}(max) is a specified value of the highest transmitting power at the system in which the transmitter is used.

In consideration of the above circumstance, the conventional transmitter including a plurality of antenna systems has the transmitting power amplifiers which are equivalent in characteristics and disposed in each of the antenna systems so as to be mounted easily. Then the transmitting power amplifier is operated so that a transmitting signal from the selected antenna systems is to satisfy the transmitting regulation even if any one of the antenna systems is selected for transmission arbitrarily.

In the above, it is described that the highest transmitting power regulation of a transmitter having a plurality of antenna systems satisfies the equation (2). Here, total transmitting power of the transmitter in the equation (2) (=N*T_{xPow}) is desirably capable of transmitting up to T_{xPow}(max) as far as satisfying a regulation about transmission from the viewpoint of widening communication area, that is, to satisfy the following equation (3):
N*T_{xPow}=T_{xPow}(max) (3)

The equation (4) is obtained from the equation (3) after dB conversion:
T_{xPow}=T_{xPow}(max)−10*log10(N) [dB] (4)

The equation (4) means that the average transmitting power T_{xPow} transmitted from each antenna system needs to be varied in accordance with the number, N, of the antenna systems to be used in a transmitter in order that the transmitter having the plurality of antenna systems satisfies a transmitting power regulation. Here, reducing T_{xPow} is equivalent to having a large back-off in FIG. 4.

Table 1 expresses numerically a relationship between the number N of antenna systems to be used in the transmitter and average transmitting power T_{xPow} transmitted from each antenna system in the equation (4). According to Table 1, for example, when the number of transmitting antenna systems is N=10, T_{xPow} needs to be reduced by 10 dB (the back-off needs to be enlarged by 10 dB) than T_{xPow} in the case where the number of transmitting antenna systems is N=1.

TABLE 1
Average transmitting power at each antenna with respect to
the number of transmitting antenna systems to be used

| | Transmitting power at each |
|---|---|
| The number of transmitting | antenna system |
| antenna systems to be used N | T_{xPow}[dB] |
| 1 | T_{xPow}(max) − 0.0 |
| 2 | T_{xPow}(max) − 3.0 |
| 3 | T_{xPow}(max) − 4.8 |
| 4 | T_{xPow}(max) − 6.0 |
| . | . |
| . | . |
| . | . |
| 10 | T_{xPow}(max) − 10.0 |

In the conventional art, as described above, each antenna system has a transmitting power amplifier with equivalent characteristic disposed therein. The transmitting power amplifiers need to be operated with a back-off which satisfies modulation accuracy of the specified largest modulation multivalue number even in case of transmission by one antenna system. Therefore, when a plurality (the number, N) of transmitting antenna systems are used, the back-off needs to be enlarged compulsorily (T_{xPow} needs to be reduced) in order to satisfy the highest transmitting power regulation as described above.

As described, by enlarging a back-off, distortion of a signal by a transmitting power amplifier is reduced, and it works for the improvement of the modulation accuracy. However, modulation accuracy is also determined by implementation loss, such as a phase noise of an oscillator, which is not depending on a transmitting power value of a transmitting power amplifier. Therefore, even if the back-off is enlarged beyond necessity and distortion of the signal by the transmitting power amplifier is reduced, the modulation accuracy hits a peak because the implementation loss such as the phase noise becomes a dominant determiner. This means that power consumption and a mounting area of the transmitting power amplifier are used unnecessarily, so miniaturization of a communication apparatus is not realized, and prolonged using time of a battery-powered communication apparatus is not reduced. The problem in this field is that such negative effects should be prevented from generating while necessary modulation accuracy for communication is satisfied at each antenna system.

The conventional transmitter described above has had a problem, that is, total power consumption of a transmitting power amplifier is increased. This is because a plurality of antenna systems has transmitting power amplifiers being equivalent in characteristics respectively so as to ensure necessary modulation accuracy for communication at each antenna system.

### SUMMARY OF THE INVENTION

An object of the present invention is to provide a transmitter capable of reducing power consumption and a mounting area of a transmitting power amplifier while necessary modulation accuracy is ensured even in the case where a plurality of antenna systems has transmitting power amplifiers disposed respectively.

In order to achieve the above object, a transmitter according to the present invention comprises: a plurality of antenna systems configured with a plurality of transmitting antennas, and a plurality of transmitting power amplifiers disposed at the plurality of transmitting antenna respectively, wherein at least one of the plurality of transmitting power amplifiers has an amplification characteristic different from amplification characteristics of the other transmitting power amplifiers.

Namely, the present invention is about the transmitter having at least two or more antenna systems in which a transmitting power amplifier is provided per transmitting antenna, wherein at least one of the transmitting power amplifiers to be used in each antenna system has an amplification characteristic different from amplification characteristics of the other transmitting power amplifiers.

According to the present invention, at least one of the plurality of the transmitting power amplifiers has an amplification characteristic different from amplification characteristics of the other transmitting power amplifiers, which enables an antenna system having a transmitting power amplifier with optimum amplification characteristic to be selected in accordance with the designated number of transmitting antenna systems to be used and necessary modulation accuracy.

Therefore, the power consumption or the mounting area can be reduced while necessary modulation accuracy for communication is satisfied even in the case with the plurality of antenna systems.

Moreover, the amplification characteristic may be a saturation output power value in another transmitter according to the present invention.

Furthermore, a transmission control section may be provided so as to select an antenna system to be used among the plurality of antenna systems based on designated modulation information.

As the modulation information, the transmission control section may use information either on the number of active transmitting antenna systems, a coding rate, a modulation multivalue number, a receiving error rate of a receiver, or a combination of those.

As explained above, according to the present invention, an effect can be achieved where power consumption or the mounting area can be reduced while necessary modulation accuracy for communication is satisfied, which has been the problem with the conventional transmitter having a plurality of antenna systems.

### BRIEF DESCRIPTION OF THE DRAWINGS

FIG. 1 is a block diagram showing a configuration of a transmitter according to an embodiment of the present invention.

FIGS. 2A-2D are diagrams showing relationships between output signals and gains of transmitting power amplifiers 1-4 according to an embodiment of the present invention.

FIG. 3 is a block diagram showing a configuration of a conventional transmitter having a plurality of antenna system.

FIG. 4 is a diagram showing a relationship of a gain and consumption power of an amplifier with output power of the transmitting power amplifier.

FIG. 5 is a diagram for explaining transmission spectrum.

### DESCRIPTION OF THE PREFERRED EMBODIMENTS

Next, an embodiment of the present invention will be described in detail by referring to the accompanying drawings.

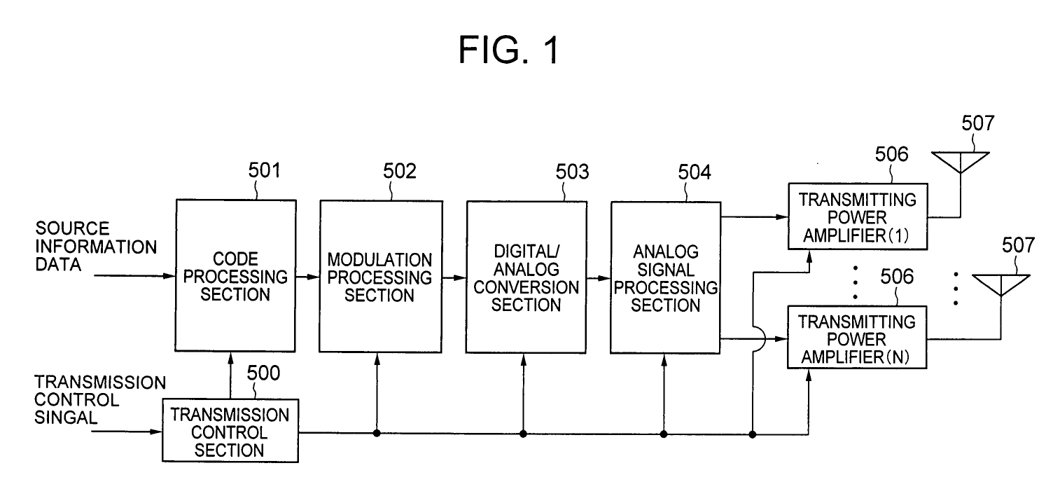

A transmitter according to the present embodiment comprises basically, as shown in FIG. 1: two or more antenna systems including a transmitting antenna 507 for radiating a transmitting radio wave into the air and transmitting power amplifier 506 for amplify a transmitting signal so as to provide it to the transmitting antenna 507; and transmission control section 500, as a fundamental configuration. Two or more transmitting antennas 507 are provided (the number, N), and also N of transmitting power amplifiers 506 are provided which correspond to N of those transmitting antennas 507.

In FIG. 1, 501 is a code processing section, 502 is a modulation processing section, 503 is a digital/analog conversion section, and 504 is an analog signal processing section.

The transmission control section 500 varies average transmitting power transmitted from each of the antenna systems in accordance with the number of antenna systems (506, 507) to be used. Specifically, the transmission control section 500 reduces the average transmitting power with an increase in the number of antenna systems to be used. More specifically, transmitting power amplifiers 506 in different amplification characteristics are used as the transmitting power amplifier 506. Then the transmission control section 500 selects an antenna system adapted for modulation information and combines the transmitting power amplifiers in different amplification characteristics according to the number of antenna systems to be used, so that the average transmitting power transmitted from each antenna system is varied. The transmitting power amplifiers with different values of saturation output power are used as the transmitting power amplifiers 506 in different amplification characteristics.

Moreover, the transmission control section 500 generates information on such as about a coding rate, a modulation multivalue number, and the number of active transmitting antenna systems in accordance with a received transmission control signal, and notifies the code processing section 501, the modulation processing section 502, the digital/analog conversion processing section 503, the analog signal processing section 504 and the transmitting power amplifier 506 of the information.

The code processing section 501 encodes source information data for the active antenna system based on the information on a coding rate and the number of active antenna system received from the transmission control section 500. The modulation processing section 502 conducts a multivalued modulation processing such as BPSK, QPSK, 16QAM and 64QAM with respect to the active antenna system based on the information on the modulation multivalue number and the number of active antenna systems received from the transmission control section 500.

The digital/analog conversion processing section 503 converts a digital signal with respect to the active transmitting antenna system into an analog signal in accordance with the information on the number of active transmitting antenna systems received from the transmission control section 500. The analog signal processing section 504 conducts an analog signal processing with respect to the active transmitting antenna system in accordance with the information on the number of active transmitting antenna systems received from the transmission control section 500.

N of the transmitting power amplifiers 506 amplifies inputting signals for the active transmitting antenna system in accordance with the information on the number of active transmitting antenna system received from the transmitting control section 500. N of transmitting antennas 507 radiates respectively an output signal from the transmitting power amplifier 506 with respect to the active antenna system as a radio signal in accordance with the information on the number of active transmitting antenna systems received from the transmission control section 500.

Here, with the viewpoint of lowering power consumption, a non-active transmitting antenna system is desirably to be left by the above processing (energy is not provided from a power supply).

Moreover, transmission control section 500. also selects an antenna system, which satisfies a transmitting regulation, among N of the antenna systems for the active antenna system based on the modulation information, such as the information on the coding rate, the modulation multivalue number, the number of active transmitting antenna systems, and the receiving error rate of the receiver which are generated based on received a transmission control signal. Hereinafter, to simplify an explanation, the case is described where the information on the number of active transmitting antenna systems is utilized for the modulation information.

The essential parts of the transmitter according to the present embodiment are that at least two or more kinds of transmitting power amplifiers having different saturation output power values are used as the transmitting power amplifiers 506 (the total number, N), each of which is mounted on N numbers of the antenna systems respectively, and that the antenna systems satisfying a transmitting regulation are selected depending on the information on the number of active transmitting antenna systems.

To simplify an explanation, the case is considered in the following example where the number of transmitting antenna systems is N=4. Here, a back-off set with the transmitting power amplifier is BO. When the number of transmitting antenna systems is “4”, BO satisfies a modulation accuracy regulation for each antenna system in transmission with one antenna system.

In consideration of the above, the transmitting power amplifiers 1-4 having different saturation output power Pₛₐₜ as shown below are prepared. Here, the saturation output power of the transmitting power amplifiers 1-4 are described as Pₛₐₜ (1)-(4) respectively.

In the following explanation, the point is that each transmitting power amplifier has different saturation output power Pₛₐₜ, and the BOs set for simple explanation are not necessary to be same between each amplifier.
Transmitting power amplifier 1:

$$\begin{matrix}Saturation output power {P}_{sat} ( 1 ) = {T}_{x Pow} ( max ) + BO - \\ 10 * log 10 ( N = 1 ) dB \\ = {T}_{x Pow} ( max ) + BO - 0.0 dB\end{matrix} \qquad ( 5 )$$

Transmitting power amplifier 2:

$$\begin{matrix}Saturation output power {P}_{sat} ( 2 ) = {T}_{x Pow} ( max ) + BO - \\ 10 * log 10 ( N = 2 ) dB \\ = {T}_{x Pow} ( max ) + BO - 3.0 dB\end{matrix} \qquad ( 6 )$$

Transmitting power amplifier 3:

$$\begin{matrix}Saturation output power {P}_{sat} ( 3 ) = {T}_{x Pow} ( max ) + BO - \\ 10 * log 10 ( N = 3 ) dB \\ = {T}_{x Pow} ( max ) + BO - 4.8 dB\end{matrix} \qquad ( 7 )$$

Transmitting power amplifier 4:

$$\begin{matrix}Saturation output power {P}_{sat} ( 4 ) = {T}_{x Pow} ( max ) + BO - \\ 10 * log 10 ( N = 4 ) dB \\ = {T}_{x Pow} ( max ) + BO - 6.0 dB\end{matrix} \qquad ( 8 )$$

Here, saturation output power Pₛₐₜ (1)-(4) of the transmitting power amplifiers 1-4 can be described respectively as follows according to the equation (5), Pₛₐₜ (1)=T_{xPow}(max)+BO.
Saturation output power (1)=Pₛₐₜ (1) dB (9)
Saturation output power (2)=Pₛₐₜ (1)−3.0 dB (10)
Saturation output power (3)=Pₛₐₜ (1)−4.8 dB (11)
Saturation output power (4)=Pₛₐₜ (1)−6.0 dB (12)

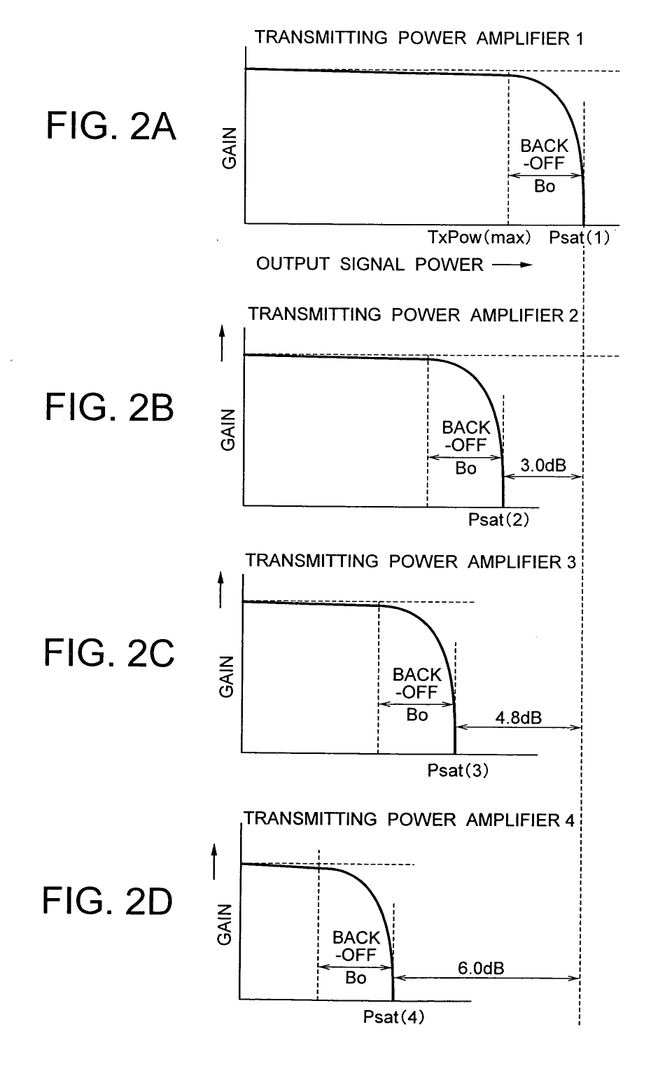

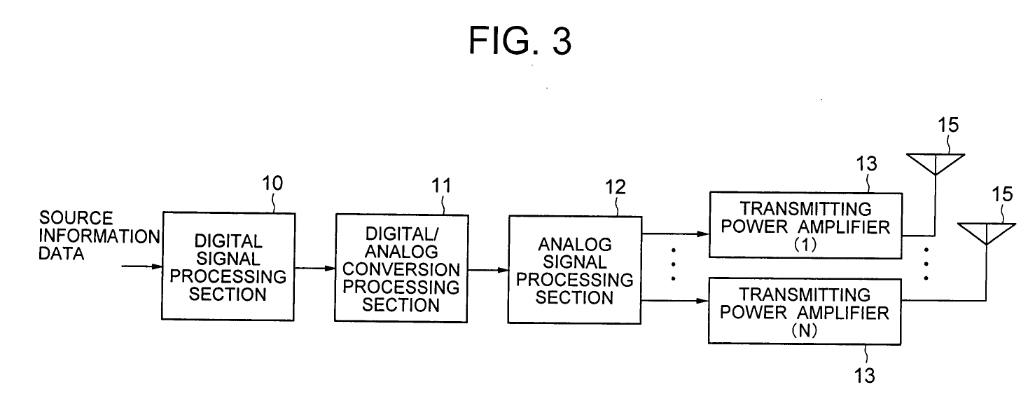

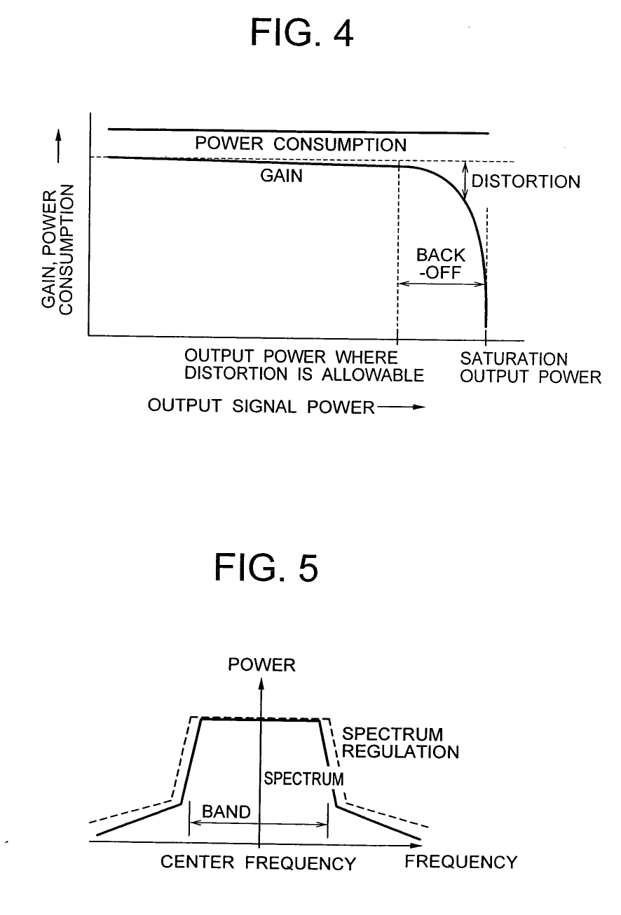

Relationships between the transmitting power amplifiers 1-4 are shown in FIGS. 2A-2D. FIGS. 2A-2D are diagrams showing the relationships between output signal power and a gain of the transmitting power amplifiers 1-4 respectively.

When the number of active transmitting antenna systems is “1”, the transmission control section 500 controls the antenna system mounting the transmitting power amplifier 1 with the saturation output power Pₛₐₜ (1) to be used. When the number of active transmitting antenna systems is “2”, the transmission control section 500 controls two antenna systems mounting the transmitting power amplifiers 1 and 2 respectively with the saturation output power Pₛₐₜ (1) and Pₛₐₜ (2) to be used. When the number of active transmitting antenna systems is “3”, the transmission control section 500 controls three antenna systems mounting the transmitting power amplifiers 1-3 respectively with the saturation output power Pₛₐₜ (1), Pₛₐₜ (2) and Pₛₐₜ (3) to be used. When the number of active transmitting antenna systems is “4”, the transmission control system 500 controls four antenna systems mounting the transmitting power amplifiers 1-4 respectively with the saturation output power Pₛₐₜ (1), Pₛₐₜ (2), Pₛₐₜ (3) and Pₛₐₜ (4) to be used.

As described, the transmission control section 500 selects an antenna system to be used based on the number of active transmitting antenna systems, and thereby a necessary back-off with respect to the transmitting power saturation output power is ensured in the transmitting power amplifiers at each antenna system.

For example, when the number of the transmitting antenna systems is “2”, transmitting power T_{xPow} at each antenna system is T_{xPow}(max)−3.0[dB] as shown in the above Table 1. Since the number of the transmitting antenna systems is “2”, the transmission control section 500 selects two antenna systems mounting the transmitting power amplifiers 1 and 2 from the four transmitting power amplifiers 1-4 in the above, for the active antenna systems. Here, the saturation output power value Pₛₐₜ (1) of the transmitting power amplifier 1 is T_{xPow}(max)+BO, and the saturation output power value Pₛₐₜ (2) of the transmitting power amplifier 2 is Pₛₐₜ (1)−3.0=T_{xPow}(max)BO−3.0[dB]. That is, as the back-offs, BO+3.0[dB] is ensured with the transmitting power amplifier 1, and BO[dB] is ensured with the transmitting power amplifier 2.

According to the above explanation of the present embodiment, the case is described where the saturation output power values are used as an amplification characteristic of the transmitting power amplifier 506, however, the present invention is not limited to such case. The present invention can be applied to the case with a plurality of transmitting power amplifiers which has different amplification characteristics other than the saturation output power values.

Further, according to the above description, the transmission control section 500 is to select an antenna system to be used based on the number of active transmitting antenna systems, however, the transmission control section 500 may select an antenna system to be used based on the modulation information such as about a coding rate, a modulation multivalue number, and the like.

In general, the higher the saturation output power is, the higher modulation accuracy become at the transmitting power amplifier. The information on the modulation accuracy of each transmitting power amplifier (1)-(N) 506 is to be stored at the transmission control section 500 in advance. The transmission control section 500 selects a transmission power amplifier which satisfies the necessary modulation accuracy among the plurality of transmitting power amplifiers (1)-(N) 506 so as to select an antenna system to be used.

Further, the transmission control section 500 may select an antenna system to be used based on the information on a receiving error rate of a receiver, or receiving information such as receiving power. For example, an antenna system with high modulation accuracy is to be selected when the error rate is high, and an antenna system with low modulation accuracy is to be selected when the error rate is low.

Moreover, when there is a plurality of modes of transmission rates depending on combinations of a plurality of coding rates and a plurality of modulation multivalue numbers, the transmission control section 500 may select an antenna system to be used in consideration of modulation accuracy for a mode of each transmission rate.

Next, the reason will be described why a transmitter according to the present embodiment can reduce power consumption comparing with a conventional transmitter.

A function of the essential part of the present embodiment is that two or more transmitting power amplifiers having different saturation output power are used so as to satisfy a transmitting regulation and to achieve low power consumption.

In order to describe the function, the case will be considered in the following example where the number of active transmitting antenna systems is N=4. In this case, according to the equations (1), (10), (11), and (12), the total power consumption P_{dc}(Total) of the four transmitting power amplifiers is:

$$\begin{matrix}{P}_{dc} ( Total ) = ( 1 + 1 / 2 + 1 / 3 + 1 / 4 ) * {P}_{sat} \\ = 2.08 * {P}_{sat}\end{matrix}$$

when Pₛₐₜ (1) in the true value (the normal value that is not in dB) is expressed as Pₛₐₜ, and P_{dc}(Total) of the conventional art (with four same transmitting power amplifiers used) is:

$$\begin{matrix}{P}_{dc} ( Total ) = ( 1 + 1 + 1 + 1 ) * {P}_{sat} \\ = 4 * {P}_{sat}\end{matrix}$$

Here, η max is to be fixed in the equation (1).

Consequently, it is found that P_{dc}(Total) is reduced by 2.08/4.0=52% comparing with the conventional art, that is, power consumption of a transmitting power amplifier due to an increase of the number of transmitting antenna systems is reduced. Further, four of the transmitting power amplifiers of which saturation output power values are Pₛₐₜ (1) are used in the conventional art, on the other hand, amplifiers having three of saturation output power values (Pₛₐₜ (2), Pₛₐₜ (3), Pₛₐₜ (4)), which is smaller at least than Pₛₐₜ (1), are also used in the present embodiment, and thereby mounting areas covered by four of the transmitting power amplifiers can be also reduced. The above is described about the case where the number of active transmitting antenna systems is N=4. The case with N>1 can be also discussed in the same way.

As described in the above, according to a transmitter of the present embodiment, power consumption and a mounting area can be reduced while necessary modulation accuracy for communication is satisfied, which has been the problem with a conventional transmitter having a plurality of antenna systems.

What is claimed is:

1. A transmitter comprising:
two or more antenna systems having a transmitting antenna for radiating a transmitting wave into an air, and a transmitting power amplifier for amplifying power of a transmitting signal so as to provide the transmitting signal to the transmitting antenna; and
a transmission control section; wherein
the transmission control section varies average transmitting power transmitted from each of the antenna systems in accordance with a number of the antenna systems to be used.

2. The transmitter as claimed in claim 1, wherein the transmission control section reduces the average transmitting power with an increase in the number of the antenna systems to be used.

3. The transmitter as claimed in claim 1, wherein
transmitting power amplifiers having different amplification characteristics are used as the transmitting power amplifier; and
the transmission control section selects the antenna system adapted to modulation information and combines transmitting power amplifiers having different amplification characteristics in accordance with the number of the antenna systems to be used, so that the transmission control section varies average transmitting power transmitted from each antenna system.

4. The transmitter as claimed in claim 1, wherein transmitting power amplifiers having different saturation output power values are used as the transmitting power amplifiers having different amplification characteristics.

5. The transmitter as claimed in claim 3, wherein information on the number of active antenna systems is used as the modulation information.

6. The transmitter as claimed in claim 3, wherein information on a coding rate is used as the modulation information.

7. The transmitter as claimed in claim 3, wherein information on a modulation multivalue number is used as the modulation information.

8. The transmitter as claimed in claim 3, wherein information on a receiving error rate of a receiver is used as the modulation information.
